(19) United States
(12) Patent Application Publication
(10) Pub. No.: US 2009/0211319 A1
(43) Pub. Date: Aug. 27, 2009

(54) LOCKS AND INSERTS THEREFOR

(76) Inventor: Scott Alexander McCormack, Cardiff (GB)

Correspondence Address: KING & SCHICKLI, PLLC, 247 NORTH BROADWAY, LEXINGTON, KY, 40507, US

(21) Appl. No.: 12/389,881

(22) Filed: Feb. 20, 2009

(30) Foreign Application Priority Data
Feb. 22, 2008 (GB) 0803281.5

(51) Int. Cl. E05B 51/00; E05B 17/22; E05B 47/00; E05B 49/04; E05B 49/02

(52) U.S. Cl. 70/263; 70/431; 70/277; 70/278.1

(57) ABSTRACT

A cylinder lock insert 10 has a manually operable knob 14 which is used to operate a lock bolt 6 of a rim lock 8 or the like. The knob 14 substantially encloses a lock input means 30 which is preferably a finger or thumb print recognition device. Correct user input causes a controller to engage a solenoid operated clutch 16 which in turn allows torque from the manual turning of knob 14 to be transmitted to the mechanism of the bolt 6. The lock may be rechargeable by means of a solar cell 34 and/or a knob operated dynamo (74 FIG. 4).

This invention relates to locks and inserts for those locks, and in particular to cylinder locks and cylinder inserts therefor.

Cylinder locks are well known. They generally have a lock mechanism and a separate insert in the shape of a cylinder, operable using a key to move the lock mechanism. Traditional rim cylinder barrel locks are commonly used for door locks but suffer from various disadvantages because a key is required.

In GB2402428 there is shown a cylinder lock insert which is operated by a keypad, without the need for a key. Correct operation of the keypad enables a user to rotate a projecting knob to operate a cylinder lock mechanism. The knob can be vandalised and provides only a small area for gripping and turning. Also it is not aesthetically pleasing to many people.

Locks which do not use keys have been proposed but these tend to be bulky and are not suitable for use as cylinder lock inserts.

Accordingly this invention provides a cylinder insert for use in a cylinder lock of the type comprising a housing for attachment to a structure and including a bolt or latch operably moveable from a closed to an open position, said cylinder insert comprising: user input device for receiving unlocking information from the user; a controller for determining the validity of the user input; a manually rotatable unlocking knob for operating said bolt or latch, the knob extending substantially peripherally around the input device; and a drive rotatable about an axis, for driveably connecting the knob to the bolt or latch, and for transmitting rotation of the knob in use to the cylinder lock along said axis to cause said bolt or latch to move from its locking position to its unlocking position, the drive including a coupling, said coupling being responsive to said controller to selectively engage said drive to allow transmission of said rotation to said cylinder lock along said axis when said controller determines valid user input.

In an embodiment, said knob has a cylindrical outer wall, for gripping by a user during operation, and a recess for housing at least partially said input device, the recess having a volume defined by said outer wall and two spaced planes in which the ends of the wall lie.

Conveniently said recess houses also said controller.

Preferably the cylinder insert further comprises a body, generally stationary in use, for rotatably supporting the knob and wherein at least a part of the coupling and drive are supported by the knob.

In an embodiment said knob is rotatable to cause rotation of the drive and, when said coupling is engaged, said movement of the bolt or latch.

Preferably said input device is a keypad, a wireless (for example radio frequency, infra red) receiver, a microphone, an image sensor, a magnetic sensor, a data input, or the like In one embodiment said unlocking information includes: a predetermined sequence of user keypad pushes; an electromagnetic signal from a remote key fob, mobile telephone or other radio frequency or infra-red or sound signal generator; a sound or spoken words from a user; a finger/thumb print, or retinal scan; magnet strip data from a credit card or the like; or a facial image; data input; or the like.

Preferably the controller can be updated with information.

More preferably the input device further includes an interface for connecting an external data source to the controller, and for uploading data for allowing the controller to determine the validity of further user input.

Preferably the coupling is in a disengaged state when not responding to the controller.

In one embodiment the coupling comprises an electro-magnetic clutch and when the clutch is in a disengaged state the knob can rotate freely without causing the bolt or latch to move.

Preferably the drive includes a friction device, such that constant rotation of the knob, when the clutch is disengaged, does not cause movement of the bolt or latch.

The clutch may include complementary sections which are brought together into an engaged position and/or withdrawn into a disengaged position by means of an electrically operated solenoid.

The input device, controller and solenoid may be powered by an electrical power source housed within the recess.

The power source may be rechargeable, by means of light energy, or by means of mechanical energy obtained from the turning of the knob in use.

The invention extends to a cylinder lock including a cylinder insert according to any of the preceding paragraphs.

The invention extends yet further to any novel feature mentioned herein optionally in combination with one or more further features mentioned herein.

According to a another aspect the invention relates to an electrically operable lock or lock insert, including a manually rotatable part for causing locking or unlocking action of the lock, the manually rotatable part being in driving communication with a dynamo for producing current when the manually operable part is rotated.

In an embodiment, the manually operable part is a knob having an internally toothed annulus, said annulus being in driving engagement with a pinion on the shaft of the dynamo.

The invention may be put into effect in various ways and an embodiment thereof will now be described by way of example only, with reference to the accompanying drawings, in which:—

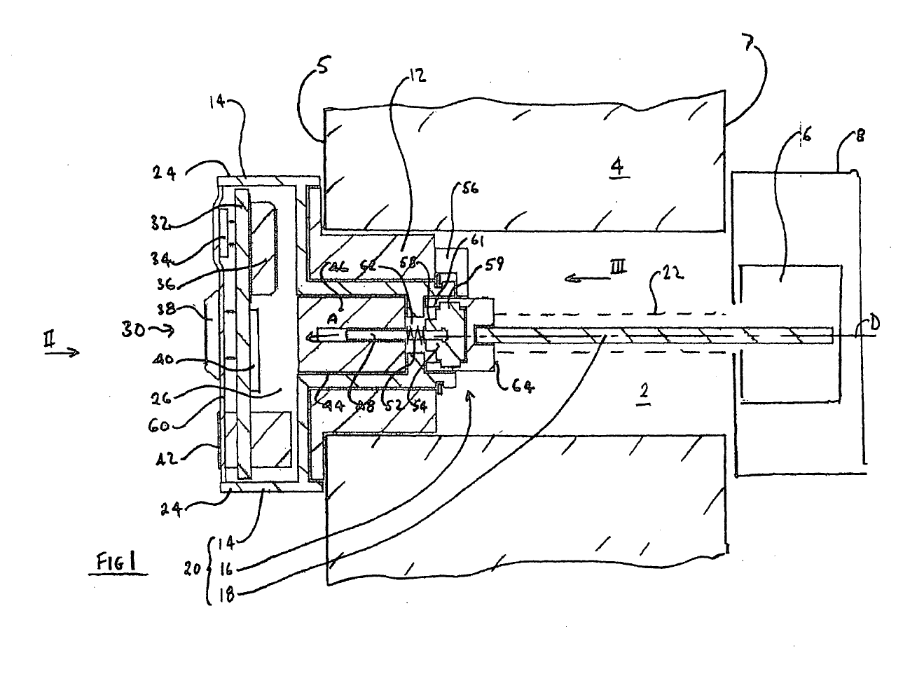

FIG. 1 shows a sectional view of a cylinder insert;

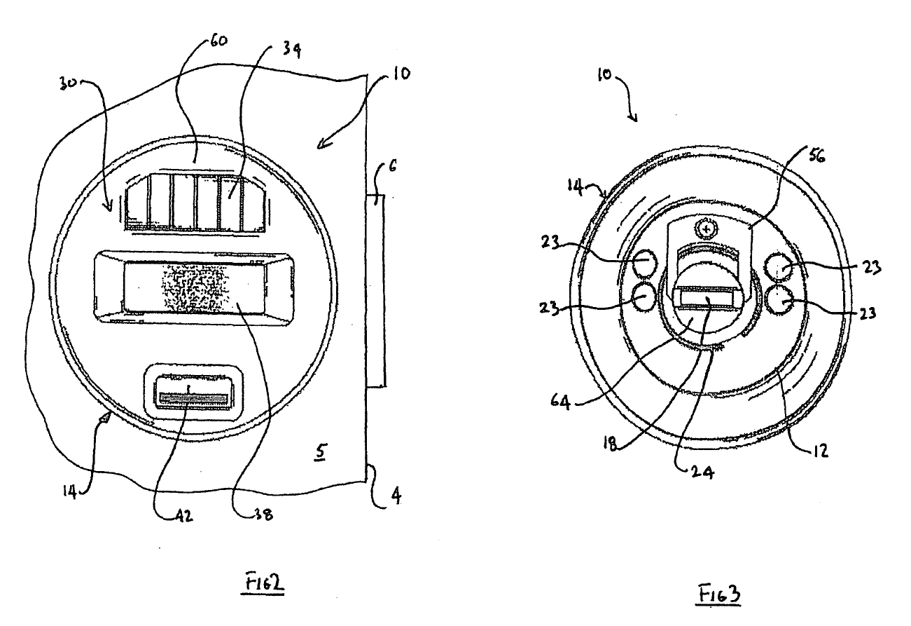

FIG. 2 shows a view in the direction of arrow II in FIG. 1;

FIG. 3 shows a view in the direction of arrow III in FIG. 1, and

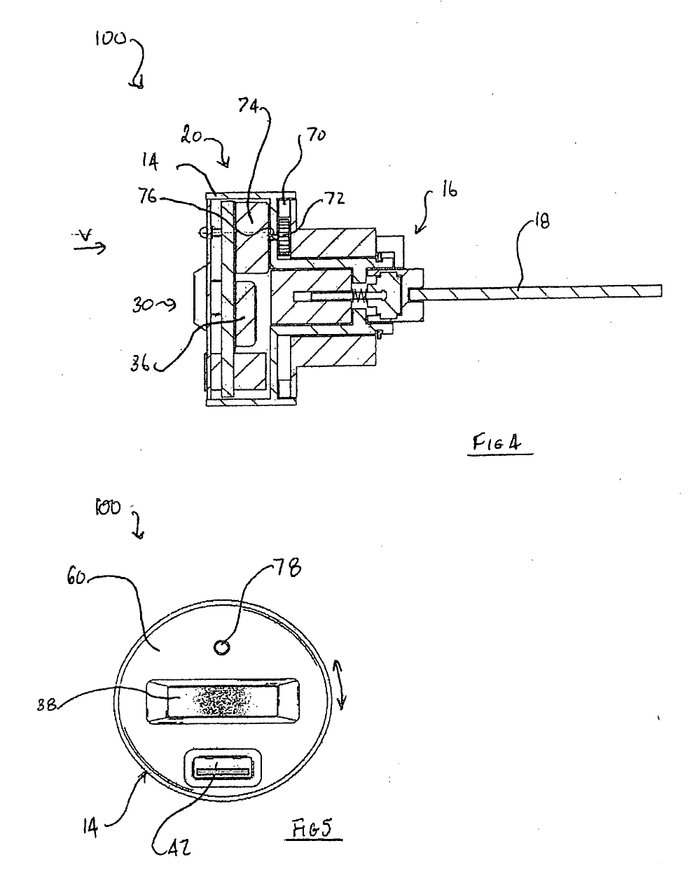

FIGS. 4 and 5 show a second embodiment of a cylinder insert.

Referring to the FIG. 1, the cylinder insert 10 comprises a main cylindrical body 12 designed to fit into an aperture 2 in a door 4, secured in position by fixing screws 22. The cylinder insert has further components, described below, which operate a bolt 6 of a conventional rim lock 8 fitted to an inside face 7 of the door 4.

The insert 10 has a cylindrical turn knob 14 arranged to protrude from the outer face 5 of the door. The turn knob 14 is rotatably mounted to the body 12 and is held axially in place by a circlip 24. The knob 14 is coupled via a two-part electro-mechanical clutch assembly 16 to a drive bar 18 which cooperates with components (not shown) within the rim lock 8. In use, when the clutch 16 is engaged and the turn knob 14 is rotated by a user, bar 18 is caused to rotate to unlock the door. Together the turn knob 14, clutch 16 and bar 18 define a drive 20 to operate the rim lock 8, which rotate about the same drive axis ‘D’.

Since the bolt 6 of the rim lock 8 is sprung to return to the locked position, there is no need to counter-rotate the knob 14 to lock the door because the force of the sprung latch will return the knob 14 to its starting position, but if the cylinder was used with a rim lock which was not so sprung then it would be necessary to rotate the knob in the opposite direction for locking the bolt 6. In this embodiment a sprung detent mechanism 56 is used to provide a positive indication of the home position for the knob 14.

The knob 14 has a cylindrical outer wall 19 which can be gripped and turned by a user. The knob has a non-slip surface, for example a knurled or roughened form. The outer walls 19 form a recess 26. Disposed substantially within the recess 26 is a user input device 30. In this embodiment the user input device 30 comprises a circuit board 32, a solar panel 34, a rechargeable battery 36, a finger or thumb print sensor 38, a controller 40, an interface 42 e.g. a USB connector, connectable to a computer and a cover plate 60. It will be noted that the input device 30, is housed substantially within the volume defined by the cylindrical wall 19 and planes contiguous with each of the two spaced ends of the wall 19 of the knob 14. Thus, the input device is at least partially protected, for example from hammer blows, by the wall 19 of the knob and does not impinge on the central space used by the solenoid and clutch mechanism. The cover plate 60 is secured in place to prevent tampering with the input device 30.

In use the device 30 is powered by the battery 36, which is kept charged by the solar panel 34. A user places his finger or thumb on the sensor 38. Alternatively the user's thumb or finger can be swiped over sensor 38 where sensor 38 is a scanning type sensor. Controller 40 is used to validate that the correct print is sensed by the sensor 38 and a solenoid 44 is selectively electrically powered for about 6 seconds. The solenoid 44 has a magnetically shielded outer coil 46 which, when powered, attracts a core 48. This force of attraction pulls core 48 in the direction of arrow A against the force of a return spring 52. Core 48 is connected to a dog 54 of clutch 16. Movement of the dog 54 causes a non-circular spigot 58 of the dog 54 to engage with a complementary non-circular aperture 62 in an inner part of the knob 14. The dog 54 has teeth 59 which can slide in complementary slots 61 in an outer clutch member 64. Thus movement in the direction of arrow A causes the spigot 58 to engage with aperture 62 and torque can be transmitted from the knob 14 to the dog 54. In turn, the teeth 59 disposed within the slots 61 in the clutch member 64 are able to transmit that torque from the dog 54 to the clutch member 64. Clutch member 64 is connected to bar 18 via a transverse pivot pin 65. When the solenoid 44 is powered the dog is moved in the direction of arrow A and this allows the turning force exerted on the knob 14 to be transmitted to the bar 18 and in turn to the latch 6 to open the lock 8, by rotation about axis ‘D’.

Stopping the power to the solenoid 44 causes the return spring 52 to move the core 48 to its starting position shown. In this starting position no rotational force from the knob 14 can be transmitted to the latch 6 because the coupling 16 is disengaged. Thus the drive between the knob 14 and drive bar 18 is disengaged along the axis D.

FIG. 2 shows a view of the front, outer face of the cylinder insert 10 in the direction of arrow II in FIG. 1. The outer wall 19 of the knob 14 is easily accessible for turning by a user and does not have significantly protruding parts. It can be seen from FIGS. 1 and 2 that the diameter of the knob is at least twice its thickness and is preferably about three times its thickness, thus providing a so called low profile fitting on door 4. It will also be noted that the axis of rotation of the knob 4 is substantially coaxial and coincident with the rotational axis of the bar 18. This simplifies construction.

FIG. 3 shows a view in the direction of arrow III in FIG. 1, with the door 4 not shown for clarity. Four threaded holes 23 are visible for accepting the securing screws 22 shown in FIG. 1. Two screws 22 would normally be used, one on each side of the body 12 and so two of the holes 23 will normally be redundant. As well as providing a detent, the mechanism 56 introduces friction to restrain clutch member 64 from rotating, for example if knob 14 is rotated rapidly by an electric drill or the like.

FIGS. 4 and 5 show views of a second embodiment, which is similar in construction to the embodiment shown in FIGS. 1 to 3, where like parts have like reference numerals. Operation of the lock 100 is identical to the operation of lock 10. Lock 100 is powered by a dynamo 74 which has an input shaft 76 attached to a pinion 72. The pinion 72 is fixed in position but is driven in rotation by an annulus 70 which rotates with knob 14. Thus manual movement of knob 14 drives the dynamo 74 to recharge a rechargeable battery 36.

FIG. 5 shows a view of arrow V in FIG. 4. Although no solar cell is shown, such a device can be incorporated also. A status L.E.D. 78 is incorporated to give an indication of the state of charge of battery 36. For example, the L.E.D. 78 can be arranged to flash or turn red when recharging motion of the knob 14 is required.

It will be understood that many modifications and variants will be apparent to the skilled addressee. A finger print sensor has been described and illustrated but it will be apparent that other input devices could be used. For example, the input device may comprise a keypad, a wireless (for example radio frequency, or infra red) receiver, a microphone, an image sensor, a magnetic sensor, data input device or the like. Thus unlocking information which can be input would then include: a predetermined sequence of user keypad pushes; an electromagnetic signal from a remote key fob or the like, a mobile telephone or other radio frequency or infra-red or sound signal generator; a sound or spoken words from a user; a physical feature of the user e.g. a retinal scan or facial image; magnet strip data from a credit card or the like; a memory store for inputting data or completing an algorithm, or the like. Any one or more of the above options could be employed in a single insert 10. The general arrangement of the insert 10 is such that it would be easy to fit different input devices into the recess 26 to suit the needs of the customer and so optional input devices can be made available.

The controller of the cylinder insert can be reprogrammed with new user information so the controller can learn to validate new user input, in any of the forms mentioned above. The preferred method of doing this is to provide a USB interface 42 for connecting to a computer, to allow software to change the information held by the controller. Alternatively a wireless, for example a standard IEEE 802.11 connection or a Bluetooth IEEE 802.15 connection, could be used to update the controller.

Power for the controller and solenoid is said to be supplied from a solar panel 34. However, alternatively or in combination, other sources of electrical power can be provided. For example a wind-up generator can be used, using mechanical energy from the turning of the knob 14. An external electricity supply can also be used.

Whilst a cylinder rim lock has been described and illustrated it will be readily understood that the invention can be applied with equal merit to other cylinder lock inserts such as so called ‘euro’ cylinders, oval cylinders, or screw in cylinders. The insert can be used to provide locking/unlocking for structures other than doors.

1. A cylinder insert for use in a cylinder lock of the type comprising a housing for attachment to a structure and including a bolt or latch operably moveable from a closed to an open position, said cylinder insert comprising:—
a user input device for receiving unlocking information from the user;
a controller for determining the validity of the user input;
a manually rotatable unlocking knob for operating said bolt or latch, the knob extending substantially peripherally around the input device; and
a drive rotatable about an axis, for driveably connecting the knob to the bolt or latch, and for transmitting rotation of the knob in use to the cylinder lock along said axis to cause said bolt or latch to move from its locking position to its unlocking position, the drive including a coupling, said coupling being responsive to said controller to selectively engage said drive to allow transmission of said rotation to said cylinder lock along said axis when said controller determines valid user input.

2. A cylinder insert according to claim 1 wherein said knob has a cylindrical outer wall, for gripping by a user during operation and a recess for housing at least partially said input device, the recess having a volume defined by said outer wall and two spaced planes in which the ends of the wall lie.

3. A cylinder insert according to claim 2, wherein said recess houses also said controller.

4. A cylinder insert according to claim 1 wherein the cylinder insert further comprises a body, generally stationary in use, for rotatably supporting the knob and wherein at least a part of the coupling and drive are supported by the knob.

5. A cylinder insert according to claim 1, wherein said input device is a keypad, a wireless (for example radio frequency or infra red) receiver, a microphone, an image sensor, a magnetic sensor, a data input, or the like.

6. A cylinder insert according to claim 5, wherein said unlocking information includes: a predetermined sequence of user keypad pushes; an electromagnetic signal from a remote key fob, mobile telephone or other radio frequency or infra-red or sound signal generator; a sound or spoken words from a user; a finger/thumb print, or retinal scan; magnet strip data from a credit card or the like; or a facial image; data input; or the like.

7. A cylinder insert according to claim 1, wherein the controller can be updated with information.

8. A cylinder insert according to claim 7, wherein the input device further includes an interface for connecting an external data source to the controller, and for uploading data for allowing the controller to determine the validity of further user input.

9. A cylinder insert according to claim 1, wherein the coupling is in a disengaged state when not responding to the controller.

10. A cylinder insert according to claim 9, wherein the coupling comprises an electro-magnetic clutch and when the clutch is in an unpowered thereby disengaged state the knob can rotate freely about the axis without causing the bolt or latch to move.

11. A cylinder insert according to claim 9, wherein the drive includes a friction device, such that constant rotation of the knob, when the clutch is disengaged does not cause movement of the bolt or latch.

12. A cylinder insert according to claim 10, wherein the clutch includes complementary sections which are brought together into an engaged position and/or withdrawn into a disengaged position by means of an electrically operated solenoid.

13. A cylinder insert according to claim 2, wherein the input device, controller and solenoid are powered by an electrical power source housed within the recess.

14. A cylinder insert according to claim 13, wherein the power source is rechargeable, by means of light energy.

15. A cylinder insert according to claim 13, wherein the power source is rechargeable, by means of mechanical energy obtained from the turning of the knob in use.

16. A cylinder insert according to claim 15 wherein the knob includes an internal annulus which co-operates with a pinion to drive a dynamo when the knob is rotated.

17. A cylinder lock including a cylinder insert according to claim 1.

18. An electrically operable lock or lock insert, including a manually rotatable part for causing locking or unlocking action of the lock, the manually rotatable part being in driving communication with a dynamo for producing current when the manually operable part is rotated.

19. An electrically operable lock or lock insert as claimed in claim 18, wherein the manually operable part is a knob having an internally toothed annulus, said annulus being in driving engagement with a pinion on the shaft of the dynamo.

20. A cylinder insert for use in a cylinder lock of the type comprising a housing for attachment to a structure and including a bolt or latch operably moveable from a closed to an open position, said cylinder insert comprising:—
a user input device for receiving unlocking information from the user;
a controller for determining the validity of the user input;
a manually rotatable unlocking knob for operating said bolt or latch, the knob extending substantially peripherally around the input device; and
a drive rotatable about an axis, for driveably connecting the knob to the bolt or latch, and for transmitting rotation of the knob in use to the cylinder lock along said axis to cause said bolt or latch to move from its locking position to its unlocking position, the drive including a coupling, said coupling being responsive to said controller to selectively engage said drive to allow transmission of said rotation to said cylinder lock along said axis when said controller determines valid user input, and wherein the knob is in driving communication with a dynamo for producing current when the manually operable part is rotated, for powering the insert.
